(19) United States
(12) Patent Application Publication
(10) Pub. No.: US 2002/0013733 A1
(43) Pub. Date: Jan. 31, 2002

(54) Information accepting and delivering system

(76) Inventor: Hiroyasu Fujiwara, Kawasaki (JP)

Correspondence Address: STAAS & HALSEY LLP, 700 11TH STREET, NW, SUITE 500, WASHINGTON, DC, 20001, US

(21) Appl. No.: 09/789,521

(22) Filed: Feb. 22, 2001

(30) Foreign Application Priority Data
May 31, 2000 (JP) 2000-163649

(51) Int. Cl. G06F 17/60

(52) U.S. Cl. 705/26

(57) ABSTRACT

A system accepting and delivering data such as an invoice, etc., received via a network is made to comprise a deal information storing unit storing the information for a deal instructed from the sending source of the data, a received information appropriateness verifying unit verifying the appropriateness of the received data based on the deal information, a received information storing unit storing the data the appropriateness of which is verified by the received information appropriateness verifying unit, and a delivering unit delivering the data to a delivery destination if the deal information includes the information of the delivery destination of the data.

### BACKGROUND OF THE INVENTION

1. Field of the Invention

The present invention relates to an electronic commerce technique, and more particularly, to a system accepting and delivering information about electronic commerce.

2. Description of the Related Art

Conventionally, systems are configured in units of sending and receiving systems in order to conduct electronic commerce. Therefore, a lot of time is required to configure a network.

Additionally, if an information accepting system stops or if information is intermittently accepted in a predetermined cycle, a preset amount of time is required until a reception result is notified to an information sender.

Furthermore, since reception standards on an information accepting side are not made public to an information sender in some cases, operations for preliminarily verifying the contents of data on an information sender side become insufficient. As a result, an error is frequently found after information is accepted.

For a three-party deal, an information receiver edits data after accepting the information, and then, sends the information to another receiver. Accordingly, a lot of time is required until a secondary receiver receives data if a primary receiver (system) stops or if an information reception process is intermittently performed in a predetermined cycle.

For electronic commerce, the above described problem conventionally exists. It is therefore demanded to accept information as a proxy on a 24-hour basis regardless of the operation cycle of an information accepting system, or to immediately send information that is properly accepted to a required business partner.

### SUMMARY OF THE INVENTION

The present invention aims at reducing time loss in electronic commerce, which is caused when information is accepted or delivered, in view of the above described problems.

According to one preferred embodiment of the present invention, a system accepting and delivering information received via a network is configured to comprise: a deal information storing unit storing the information of a deal instructed from the sending source of the received information; a received information appropriateness verifying unit verifying the of the received information based on the deal information; a received information storing unit storing received information the appropriateness of which is verified by the received information appropriateness verifying unit; and a delivering unit delivering the received information to a delivery destination if the deal information includes the information about the delivery destination.

With the above described configuration, verification of the appropriateness of received information, acceptance of received information the appropriateness of which is verified, and delivery of the received information to a delivery destination are automatically performed via a network based on electronic commerce information (deal information), thereby reducing time loss in electronic commerce, which is caused when information is accepted or delivered.

### BRIEF DESCRIPTION OF THE DRAWINGS

The present invention will be more apparent from the following detailed description when the accompanying drawings are referenced.

FIG. 1 shows the principle of the configuration according to the present invention;

FIG. 2 explains the concept of the present invention;

FIG. 3 explains the operations of the present invention;

FIG. 4 shows the configuration of a system according to the present invention;

FIG. 5 shows the flow of the system according to the present invention (No. 1);

FIG. 6 shows the flow of the system according to the present invention (No. 2);

FIG. 7 shows the flow of the system according to the present invention (No. 3);

FIG. 8 shows the flow of the system according to the present invention (No. 4);

FIG. 9 shows the flow of the system according to the present invention (No. 5);

FIG. 10 shows the configuration of a collaboration system for use in a system implementing a preferred embodiment according to the present invention; and

FIG. 11 exemplifies computer-readable storage media on which is recorded a control program.

### DESCRIPTION OF THE PREFERRED EMBODIMENTS

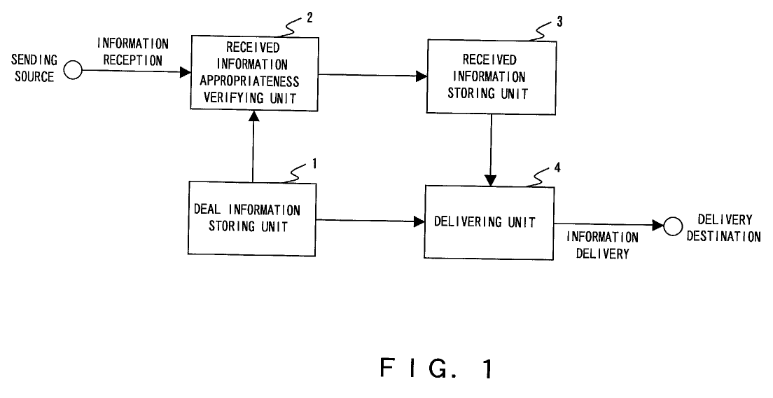

FIG. 1 shows the principle of the configuration according to the present invention.

A deal information storing unit 1 stores the information about a deal that is instructed beforehand by an information sending source.

A received information appropriateness verifying unit 2 verifies the appropriateness of information that is sent from the sending source and received via a network not shown based on the deal information stored in the deal information storing unit 1.

A received information storing unit 3 stores received information the appropriateness of which is verified by the received information appropriateness verifying unit 2 among the above described received information.

A delivering unit 4 delivers the received information to a delivery destination if the deal information stored in the deal information storing unit 1 includes the information about the delivery destination of the received information.

With the above described configuration according to the present invention, verification of the appropriateness of received information, acceptance of received information the appropriateness of which is verified, and delivery of the received information to a delivery destination are automatically performed based on electronic commerce information (deal information) instructed from a request source.

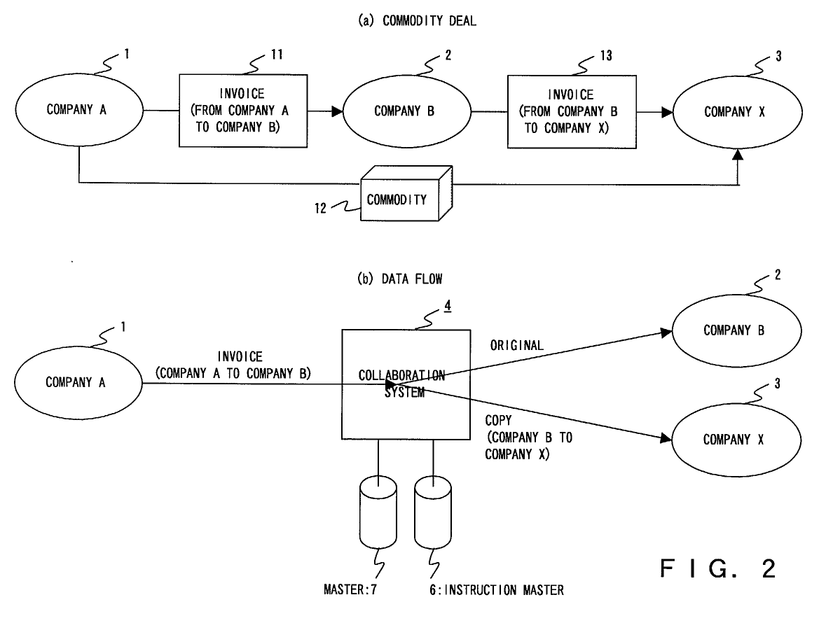

Hereinafter, a preferred embodiment according to the present invention and its operations will be sequentially described in detail by referencing FIGS. 2 through 11.

FIG. 2 explains the outline of the operations of a system implementing the present invention.

In this figure, a company A 1 is a computer system of the company A, and sends data of a commodity (data of an invoice of a commodity, etc.) to a collaboration system 4.

A company B 2 is a computer system of the company B, and receives the data such as an invoice, etc. issued by the company A 1 from the collaboration system 4.

A company X 3 is a computer system of the company X, and receives data such as an invoice issued by the company B 2 from the collaboration system 4.

The collaboration system 4 receives and delivers data (such as invoice, etc.) of a commodity as a proxy according to an instruction master 6.

In the instruction master 6, instruction information such as reception of data, editing of received data, delivery of edited data, etc. are registered.

In a master 7, data such as inventories of commodities etc. are stored.

First of all, the outline of the operations shown in FIG. 2 is described.

Upon receipt of data from a request source (for example, an invoice from the company A), the collaboration system 4 accepts the received data by referencing the instruction master 6, and stores the data in the master 7. Furthermore, if link information is registered to the information registered in the instruction master 6, the collaboration system 4 delivers the data to a delivery destination (the company X 3 in this case) according to the link information.

Note that deal information can be additionally registered to the master 6, and can be referenced at any time.

Furthermore, the collaboration system 4 edits accepted data and delivers the edited data according to the information registered to the instruction master 6.

The information registered to the instruction master 6 is written with a tag of HTML (HyperText Markup Language), etc.

With the above described operations, acceptance of information, verification of contents, and information required for a plurality of receivers are simultaneously delivered based on the standard data concerning electronic commerce, which is sent from a request source and registered to the instruction master 6, whereby not only the number of acceptance errors due to a request source but also time loss can be reduced.

FIG. 2 is further explained in detail below.

(a) exemplifies a commodity deal. Exemplified here is the concept of commerce in which the company A 1 sends a commodity 12 to the company X 3 based on a request of the company B 2, and also sends an invoice 11 of a commodity 12 (an invoice stating that the commodity 12 is sent from the company A 1 to the company B 2) to the company B 2, and the company B 2 views the invoice (from the company A to the company B) and sends an invoice 13 (from the company B to the company X) to the company X 3. This is configured by using a computer system as shown in (b) of FIG. 2, according to the present invention.

(b) shows the flow of data. The company A 1 (the computer system of the company A) sends data being an invoice to the collaboration system 4 as shown in this figure in order to implement the flow of the invoice of the commodity shown in (a) of FIG. 2. The collaboration system 4 verifies the appropriateness of the received data (the invoice (from the company A to the company B)) (verifies if information required as an invoice is lost or if an obvious error, etc. exists) by referencing the instruction master 6. If the appropriateness of the data is verified in consequence, the collaboration system 4 performs the process for accepting the data and stores the data in the master 7, and sends the original data (the invoice from the company A to the company B) to the company B 2 (the computer system of the company B). In addition, the collaboration system 4 converts the data of the invoice (from the company A to the company B) into data of an invoice (from the company B to the company X), and sends the converted data to the company X according to an instruction registered in the instruction master 6.

As described above, the collaboration system 4 is arranged and the company A 1 only sends data (an invoice (from the company A to the company B)) to the collaboration system 4, so that the collaboration system 4 can automatically perform a series of proxy processes including the sending of the data to the company B 2, the conversion of the data (into an invoice (from the company B to the company X)), and the sending of the converted data to the company X 3, according to the instruction master 6. At this time, for example, the company B2 preregisters to the instruction master: an instruction to copy the data (such as an invoice, shipping data, etc.) sent from the company A 1 to the company B 2, and to send the data to the company X after converting into data (from the company B to the company X); and an instruction to make a comparison between the data (an invoice, shipping data, etc.) sent from the company A 1 to the company B 2 and data (such as back orders, a price master, etc.) stored in the master 7, and to accept only the data the appropriateness of which is verified.

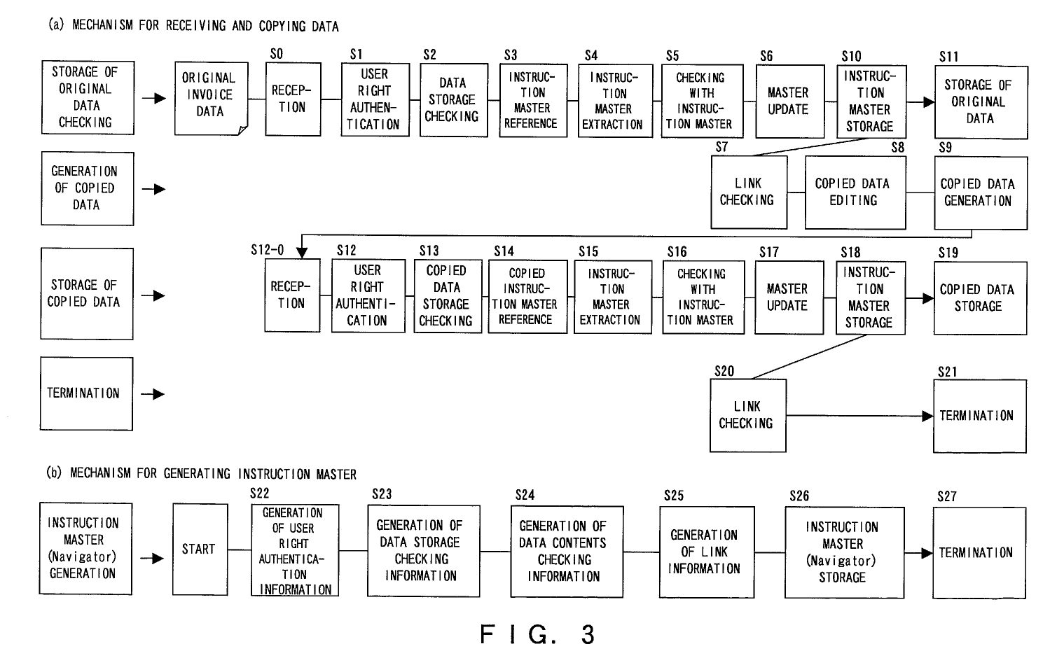

FIG. 3 explains the operations of the present invention.

(a) shows the mechanism for receiving and copying data. This figure illustrates the flow of the process starting from the top row: checking and storage of original data, generation of copied data, storage of copied data, and termination.

In (a) of FIG. 3, the collaboration system 4 shown in FIG. 2 receives the original invoice data (the invoice (from the company A to the company B) shown in (b) of FIG. 2) in step SO.

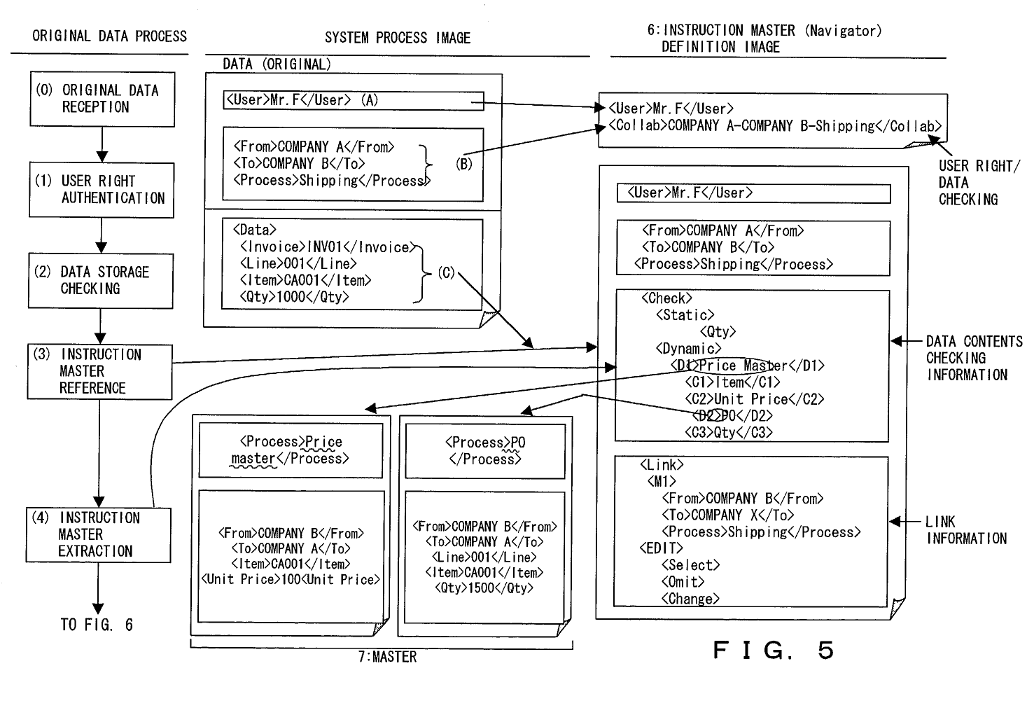

In step S1, a user right is authenticated. Namely, the user right is authenticated to execute the subsequent process by determining whether or not the user of the sending source of the received data is registered to the instruction master 6 (see (1) of FIG. 5 to be described later). If this authentication is successfully made, the process proceeds to step S2. If the authentication is unsuccessfully made, the series of processes is terminated.

In step S2, data storage checking is made. Namely, it is checked whether or not data indicating an instruction for the received data (the invoice (from the company A to the company B)) is registered to the instruction master 6 (see (2) of Fig.5 to be described later).

In step S3, the instruction master 6 is referenced.

In step S4, the instruction master 6 is extracted. In steps S3 and S4, the instruction master 6 is referenced and its corresponding portion is extracted as shown in (3) and (4) of FIG. 5 to be described later.

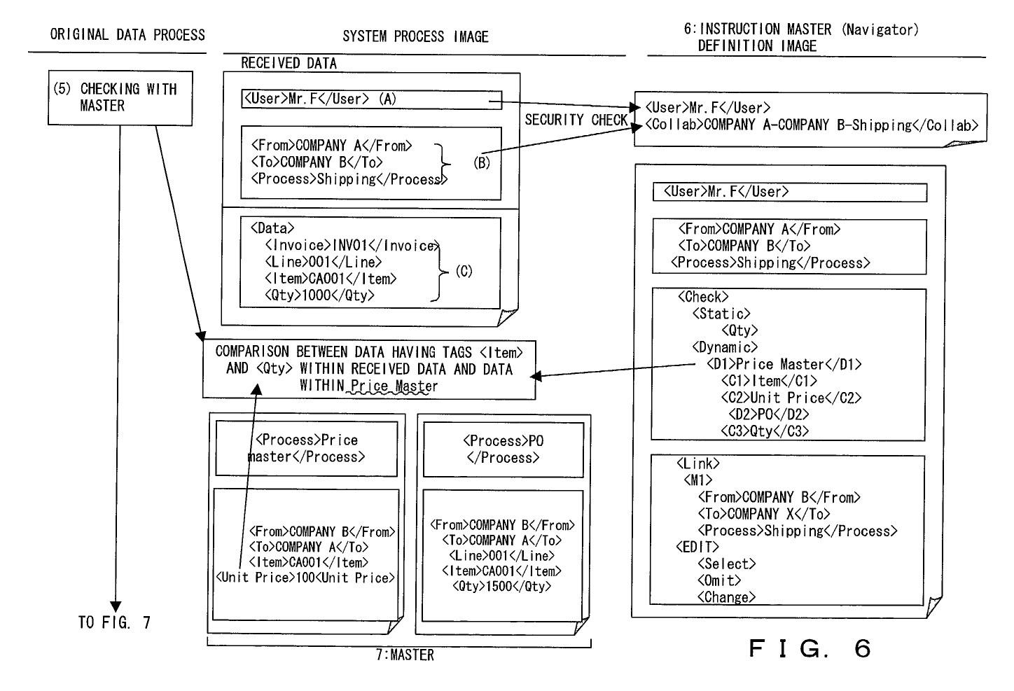

In step S5, the comparison between the received data and the instruction master extracted in step S4 is made (see (5) of FIG. 6 to be described later) In step S6, master update is made. Namely, the master 7 is updated based on the received data.

In step S10, the extracted instruction master is stored.

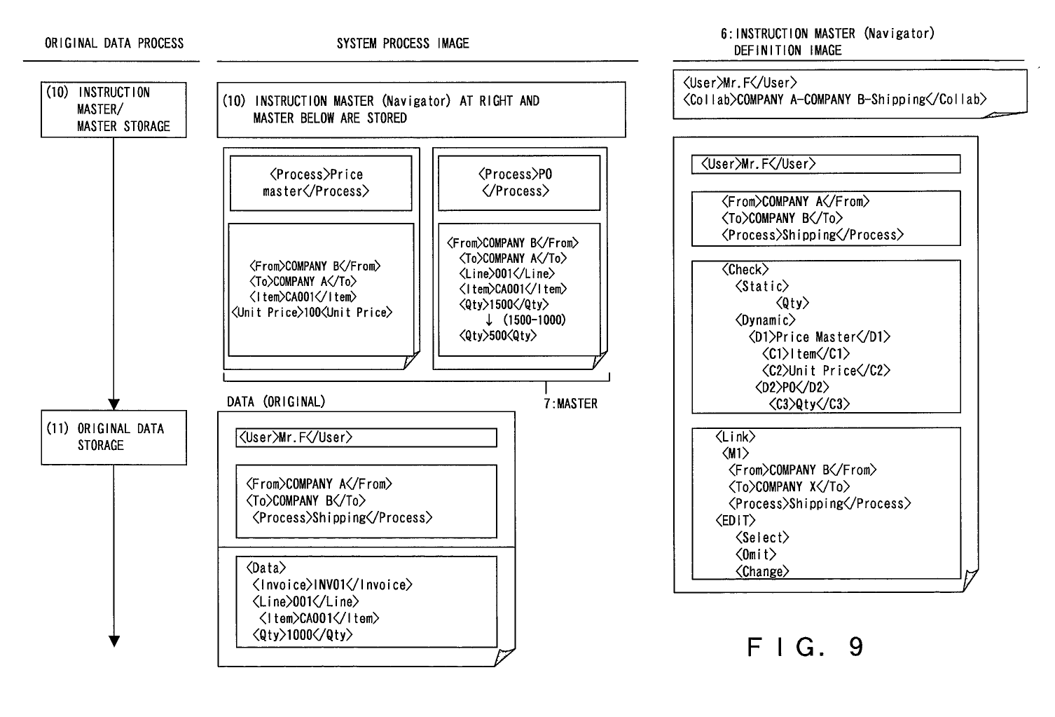

In step S11, the original data is stored. By way of example, the received original data is stored as shown in (11) of FIG. 9.

With the series of the processes in steps SO through S10, which are performed for the original data, the collaboration system 4 automatically executes proxy processes such as reception of original data, user authentication, comparison between the original data and the instruction master 6, update of the master 7, storage of received data, etc.

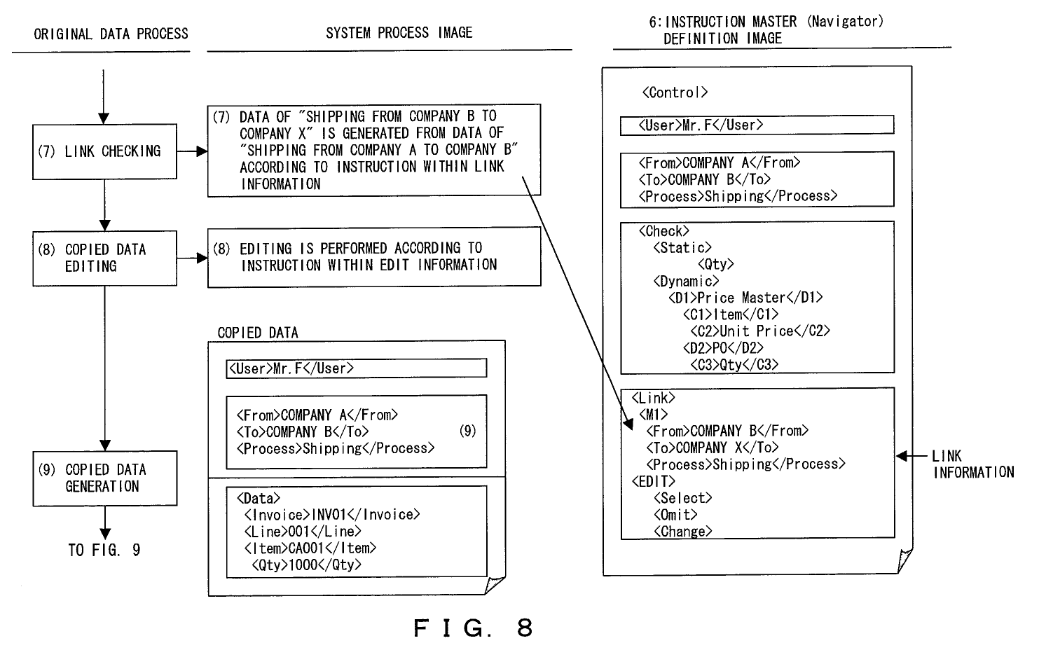

In step S7, link checking is made. Namely, it is checked whether or not link information (such as the information about the transfer destination of an invoice, conversion information, etc.) exists in the instruction master 6 as shown in (7) of FIG. 8 to be described later. If the link information exists, the process proceeds to step S8. If the link information does not exist, the series of processes is terminated.

Instep S8, copied data is edited, because the link information is proved to exist in the instruction master 6 with the process of step S7.

In step S9, copied data is generated. The processes of steps S8 and S9 are intended to copy data or to edit (change) part of the data according to link information within the instruction master 6, for example, as shown in (8) and (9) of FIG. 8 to be described later. That is, these operations are intended to generate the invoice (from the company B to the company X) from the invoice (from the company A to the company B) in the example in (b) of FIG. 2.

With the above described series of processes for generating copied data, which are performed in steps S7 through S9, the collaboration system 4 shown in FIG. 2 automatically performs a proxy process for copying and editing received data, and for generating copied data to be sent to a link destination based on the link information within the instruction master 6.

In step S12-0, the collaboration system 4 shown in FIG. 2 receives the copied invoice data (the invoice (from the company B to the company X) shown in FIG. 2)) generated with the above described process In step S12, a user right is authenticated. Namely, the user right is authenticated by determining whether or not the user of the sending source of the received copied data is registered to the instruction master 6 (in a manner similar to that described in the above step S1).

If this authentication is successfully made, the process proceeds to step S13. If the authentication is unsuccessfully made, the series of processes is terminated.

In step S13, copied data storage checking is made. Namely, it is checked whether or not data indicating an instruction for received copied data (the invoice (from the company B to the company X)) is registered to the instruction master 6 (similar to (2) of FIG. 5 to be described later).

In step S14, the instruction master 6 is referenced.

Instep S15, the instruction master 6 is extracted. In steps S14 and S15, the instruction master 6 is referenced and its corresponding portion is extracted in a similar manner as in the above described steps S3 and S4.

In step S16, the comparison between the copied data and the instruction master 6 extracted in step S15 is made (in a similar manner as in the above described step S5).

In step S17, master update is made. Namely, the master 7 is updated based on the copied data in a similar manner as in the above described step S6.

In step S18, the extracted instruction master is stored.

In step S19, the copied data is stored. Namely, the copied data is stored, for example, with a method similar to the storage of original data in (11) of FIG. 9.

With the series of processes for copied data, which are performed in the above described steps 12-0 and S12 through S19, the collaboration system 4 shown in FIG. 2 automatically performs proxy processes such as reception of copied data, user authentication, the comparison between the instruction master 6 and copied data, update of the master 7, storage of copied data, etc.

In step S20, link checking is made. Namely, it is checked whether or not link information (such as the information of the transfer destination of an invoice, conversion information, etc.) exits within the instruction master 6 in a similar manner as in the above described step S7. If the link information exists, the process proceeds to data editing in a similar manner as in step S8. If the link information does not exist, the process is terminated in step S21.

In the above described steps S20 and S21 in the example in (b) of FIG. 2, the process for searching the instruction master 6 for the link information of the copied data is performed. Since the link information does not exist within the instruction master 6, the process is terminated here.

(b) of FIG. 3 exemplifies the mechanism for generating the instruction master 6 (also referred to as a navigator).

In (b) of FIG. 3, user right authentication information is generated in step S22. Here, a user (such as Mr. F) who gives a right to make the collaboration system 4 execute the series of proxy processes is registered like the instruction master 6 of FIG. 5 to be described later.

In step S23, data storage checking information is generated. Here, information (such as “shipping from the company A to the company B”) for making security checking such as invoice contents checking is registered like the instruction master 6 of FIG. 5 to be described later. For example, the information (such as “shipping from the company A to the company B”) for checking the contents of an invoice is registered.

In step S24, data contents checking information is generated. Here, a data contents checking portion within the instruction master 6 of FIG. 5 to be described later is generated.

In step S25, link information is generated. Here, link information within the instruction master 6 of FIG. 5 to be described later is generated.

In step S26, the instruction master (navigator) 6 is stored.

In step S27, the process is terminated.

With the processes in the above described steps S22 through S27, the instruction master 6 is generated based on the information input by a user, and the generated instruction master 6 is registered to the collaboration system 4 as required, whereby it becomes possible to make the collaboration system 4 automatically perform the series of proxy processes shown in (a) of FIG. 3 according to the instruction master 6.

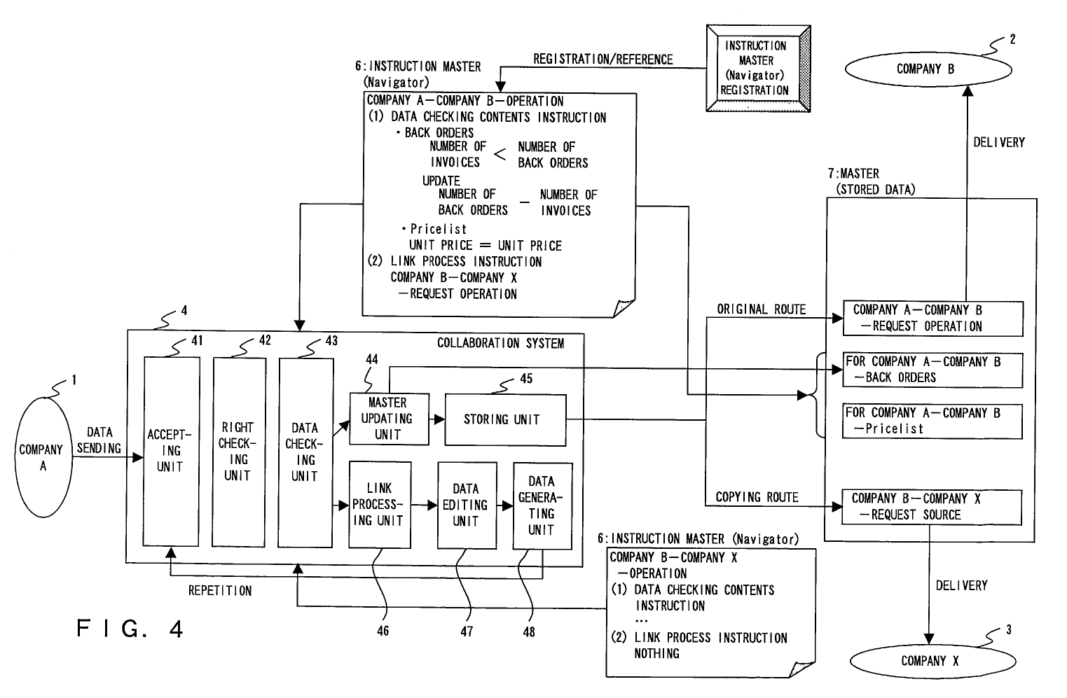

FIG. 4 shows the configuration of the system according to the present invention. Here, since a company A 1, a company B 2, and a company X 3 are the same as those indicated by the same reference numerals in FIG. 2, their explanations are omitted.

In FIG. 4, the collaboration system 4 automatically performs the proxy processes shown in (a) of FIG. 3 according to the instruction master 6. Here, the collaboration system 4 is configured by a receiving unit 41, a right checking unit 42, a data checking unit 43, a master updating unit 44, a storing unit 45, a link processing unit 46, a data editing unit 47, and a data generating unit 48.

The receiving unit 41 receives the data (such as the invoice (from the company A to the company B)) shown in (b) of FIG. 2) sent from the company A 1, etc. to a network (such as the Internet, etc.).

The right checking unit 42 checks the user right of the received data by referencing the instruction master 6.

The data checking unit 43 checks the received data (checks whether or not an instruction to perform a series of processes for the received data (such as the invoice (from the company A to the company B)) is registered to the instruction master 6) by referencing the instruction master 6.

The master updating unit 44 updates the master 7.

The storing unit 45 stores data, etc.

The link processing unit 46 issues an instruction to perform a link process according to link information if the link information of received data is registered to the instruction master 6.

The data editing unit 47 edits data (for example, edits (converts) data of a received invoice (from the company A to the company B) to data of an invoice (from the company B to the company X)) according to link information after copying the original data, if the instruction to perform the link process is issued by the link processing unit 46.

The data generating unit 48 generates data (copied data) based on a result of the editing process performed by the data editing unit 47.

In the instruction master (navigator) 6, user right authentication information, data checking information, data contents checking information, link information, etc. for received data are registered (see the instruction master 6 of FIG. 5).

The master (stored data) 7 stores data (original data, copied data, etc.) sent/received by the collaboration system 4. The data stored in the master 7 is then delivered by a delivering unit (not shown in FIG. 3), which is comprised by the collaboration system 4, according to the link information.

Next, the operations of the configuration shown in FIG. 4 will be explained.

(1) The receiving unit 41 within the collaboration system 4 receives data (such as the invoice (from the company A to the company B) shown in (b) of FIG. 2), for example, from the company A 1 via a network.

(2) The right checking unit 42 checks the user right indicated within the received data by referencing the right checking information within the instruction master 6. If the checking results in “OK” (that is, if the user name indicated by the received data matches the right checking information within the instruction master 6), the flow proceeds to (3). If the checking results in “NG”, the operations are terminated.

(3) The data checking unit 43 checks the received data (for example, checks if the invoice (from the company A to the company B) is registered to the instruction master 6) by referencing the data checking information within the instruction master 6. If the checking results in “OK”, the flow proceeds to (4). If the checking results in “NG”, the operations are terminated.

(4) The master updating unit 44 extracts the data contents checking portion within the instruction master 6, and verifies the appropriateness of the contents of the received data. If the verification results in “OK” (that is, if the data is proper data), the master updating unit 44 issues an instruction to update the master 7. Or, if the verification results in “NG”, the operations are terminated.

(5) Upon receipt of the instruction to update the master 7 from the master updating unit 44, the storing unit 45 stores the data (original and copied data) in the master 7.

(6) If the link information is registered to the instruction master 6 corresponding to the received data, the link processing unit 46 instructs the data editing unit 47 to start a link process. If the link information is not registered, the link processing unit 46 does not instruct the link process.

(7) When being instructed by the link processing unit 46 to start the link process, the data editing unit 47 copies the original data, and edits (changes) the copied data according to the link information within the instruction master 6. Here, the data editing unit 47 edits (changes), for example, the original data (the invoice (from the company A to the company B)) to the data (invoice (from the company B to the company X)).

(8) The data generating unit 48 generates copied data based on the data after being edited by the data editing unit 47.

Described in detail hereinafter is a procedure such that the company Al sends the above described data (the invoice (from the company A to the company B)) shown in FIG. 2 to the collaboration system 4, which respectively delivers the original data and its copied data to the companies B and X according to the instruction master 6.

FIGS. 5 through 9 show the flow of the system according to the present invention. An original data process shown in the upper left portion of each of Figs. 5 through 9 illustrates the above described original data process within (a) of FIG. 3. A system process image in the upper middle illustrates the processes such as copied data generation, copied data storage, etc. shown in (a) of FIG. 3. An instruction master (navigator) definition image in the upper right portion schematically illustrates a specific example of the instruction master 6 by using HTML tags.

In FIG. 5, original data is received in (0). Namely, the collaboration system 4 receives, for example, the (original) data (the invoice (from the company A to the company B) in FIG. 2), which is shown in the middle of FIG. 5, from the company A 1 via a network.

In (1), a user right is authenticated. Here, it is checked whether or not the user (Mr. F) in a portion (A) within the received data matches the corresponding user (Mr. F) indicated by an arrow of the instruction master 6 shown in FIG. 5. Here, since both of the users match, authentication is successfully made. The process therefore proceeds to (2). If the authentication is unsuccessfully made, the process is terminated.

In (2), data storage checking is made. Here, type information (shipping (from the company A to the company B)) of the invoice in (B) within the (original) data is compared with the contents checking information within the instruction master 6, which is indicated by an arrow. Since both of the information match in the example of FIG. 5, the checking results in “OK”. The process therefore proceeds to (3). If the checking results in “NG”, the process is terminated.

In (3), the instruction master 6 is referenced.

In (4), the instruction master is extracted. The checking of the user right and the data type in (1) and (2) result in “OK”. Therefore, in (3) and (4), the data contents checking information within the instruction master 6 is referenced, and the contents of the data are extracted from the instruction master 6 as shown in FIG. 5 or from the masters (masters named as “Price Master” and “PO” in FIG. 5) outside the instruction master 6, which is pointed to by the instruction master 6, as shown in FIG. 5, and used as the mater 7.

In FIG. 6, in (5), checking with a master is made. Namely, the comparison between the master 7 extracted from the instruction master 6 in (4) and the received data is made. To be more specific, data indicated by tags such as <Item> and <Qty> in a data portion of the received data (shown in (C) of FIG. 6) are compared with the data indicated by the master named as “Price Master” within the instruction master 6, which is indicated by an arrow.

Here, both of the data match, and the checking results in “OK”. The process therefore proceeds to (6). If the checking results in “NG”, the process is terminated. With the process of (5), the data on the left side of the master 7 in FIG. 6 has been checked.

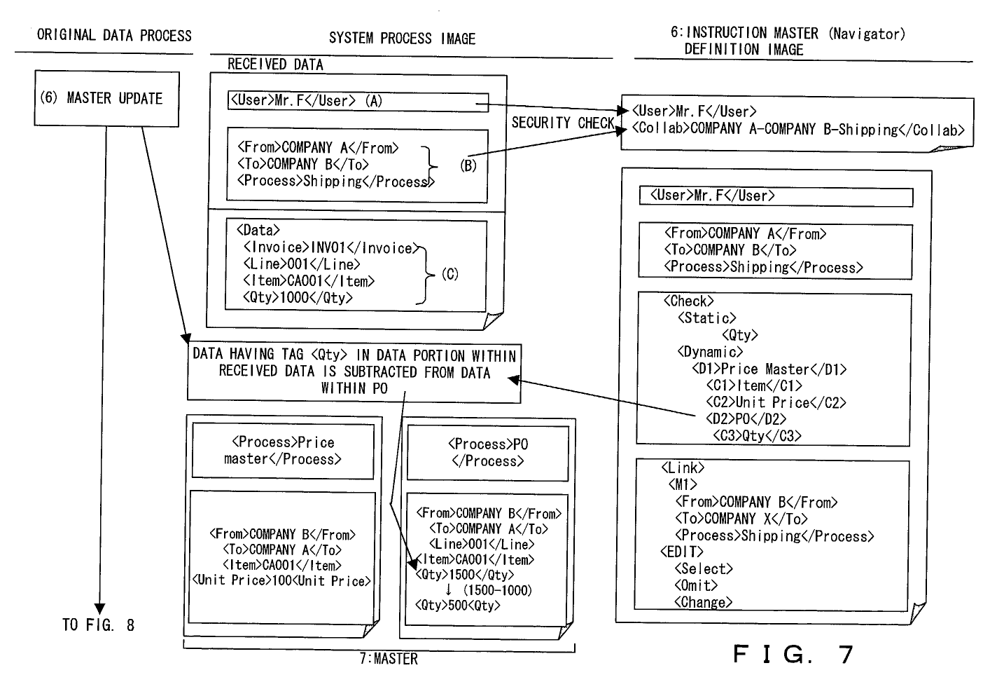

In FIG. 7, in (6), master update is made. Namely, the master 7 is updated, because the master 7 extracted from the instruction master 6 in (5) is proved to match the received data. To be more specific, the value of the data indicated by the tag <Qty> in the data portion within the received data is subtracted from the value of the PO data indicated by the arrow within the instruction master 6. Here, 1000 is subtracted from <Qty>1500<Qty> shown in the PO data within the master 7. Therefore, the <Qty>tag results in <Qty>500<Qty>.

In FIG. 8, in (7), link checking is made. Namely, link information within the instruction master 6 is read, and data of “shipping from the company B to the company X” is generated from data of “shipping from the company A to the company B” according to instructions within the link information.

Here, the link information within the instruction master 6 is referenced, and the received data of “shipping from the company A to the company B” is edited to the data of “shipping from the company B to the company X”

In (8), copied data editing is performed. Here, EDIT information within the instruction master 6 is read, and an editing process according to an instruction within the EDIT information is executed. In this example, EDIT in the link information within the instruction master 6, which is indicated by an arrow, is referenced. However, since the contents of editing instructions are empty, copied data is not edited.

In (9), copied data is generated. The copied data has the same contents except for its type portion that is changed from “shipping from the company A to the company B” to “shipping from the company B to the company X”, and is automatically generated according to the link information within the instruction master 6.

In FIG. 9, in (10), the instruction master 6 and the master 7 are stored. Namely, the instruction master 6 and the master 7, which are generated up to the process in (9), are stored (updated).

In (11), the original data is stored. Namely, the received original data is stored.

As described above, the collaboration system 4 receives data, and performs processes such as user right authentication (1), data storage checking (2), data contents checking (3) to (5), master update (6), link process (7) to (9), and master and original data storage (10) and (11), whereby proxy processes are automatically performed.

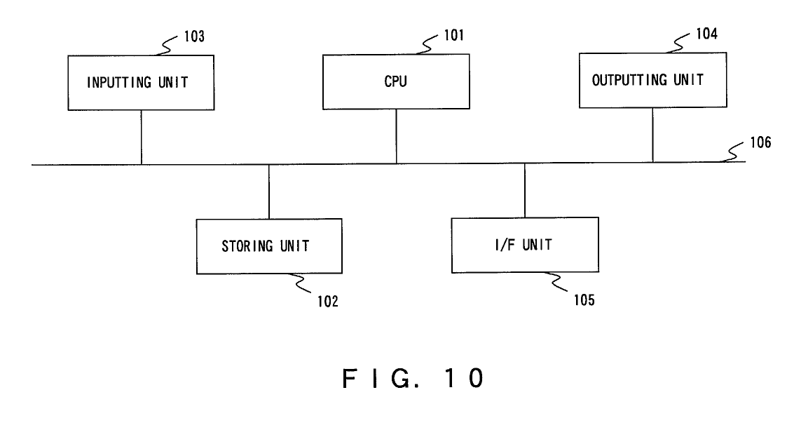

Configuration of the above described collaboration system 4 for use in the system implementing the preferred embodiment according to the present invention is shown in FIG. 10. The collaboration system 4 comprises a CPU 101, a storing unit 102, an inputting unit 103, an outputting unit 104, and an I/F unit 105, which are interconnected by a bus 106.

The CPU (Central Processing Unit) 101 controls each of the constituent elements by executing a control program. The CPU 101 executes the control program, so that the collaboration system 4 is made to execute the process steps shown in FIGS. 3 through 9.

The storing unit 102 comprises a ROM (Read-Only Memory), a RAM (Random Access Memory), a magnetic storage device, etc. The storing unit 102 stores the control program, which is executed by the CPU 101, for causing the collaboration system 4 to execute the process steps shown in FIGS. 3 through 9. The storing unit 102 is also used as a working area when the CPU 101 executes the control program, or a storage area of various types of data including the instruction master 6 and the master 7.

The inputting unit 103 comprises a mouse, a keyboard, etc. With this unit, various types of data corresponding to the operations of an administrator of the collaboration system 4 are obtained.

The outputting unit 104 comprises a display, etc. With this unit, various types of data are displayed and notified to the administrator of the collaboration system 4.

The I/F unit 105 provides an interface capability for making a connection to a network. With this unit, data can be exchanged between the computer systems (1, 2, and 3) of the companies A, B, and X via a network.

The configuration shown in FIG. 10 is similar to that of a normal computer. Accordingly, the present invention can be implemented with a normal computer as a matter of course. Also the computer systems (1, 2, and 3) of the companies A, B, and X may be configured by the computer having the normal configuration shown in FIG. 10.

To implement the present invention with the normal computer, a control program for causing a computer to execute the process steps shown in FIGS. 3 through 9 may be stored onto a computer-readable storage medium, and loaded from the storage medium to the computer, which is made to execute the program.

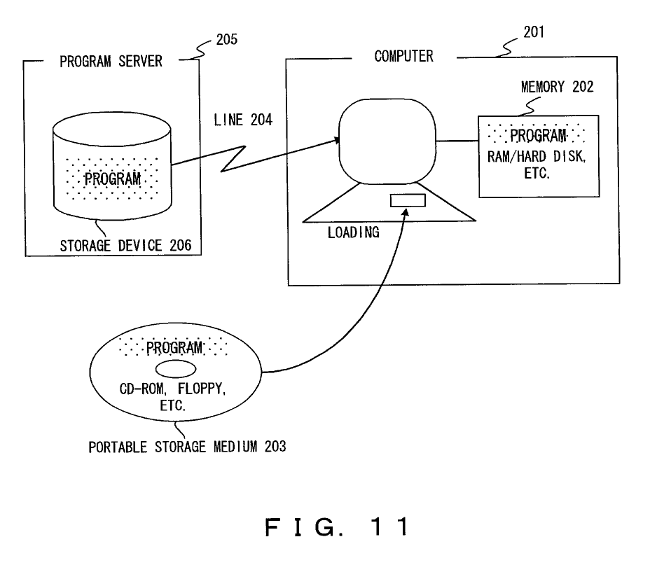

The computer-readable storage media on which is recorded the control program are exemplified in FIG. 11. As shown in this figure, for example, a memory 202 such as a ROM that is embedded into or externally attached to a computer 201, a hard disk device, etc., a portable storage medium 203 such as a floppy disk, an MO (Magneto-Optical) disk, a CD-ROM, a DVD-ROM, etc. are available as a storage medium. The storage medium maybe a storage device 206 comprised by a program server 205, which is a computer connected to the computer 201 via a line 204. In this case, a transmission signal that is obtained by modulating a carrier wave with a data signal embodying a control program is sent from the program server 205 via the line 204 being a transmission medium, and the computer 201 regenerates the control program by demodulating the received transmission signal, so that the control program can be executed.

As described above, with the collaboration system 4 implementing the present invention, when information received via a network is accepted and delivered, the appropriateness of the received information is verified based on the information about a deal instructed from the sending source of the received information, received information the appropriateness of which is verified as a result of the verification is stored, and the received information is delivered to a delivery destination if the deal information includes the information about the delivery destination of the received information.

With the configuration comprised by the collaboration system 4, verification of the appropriateness of received information, acceptance of received information the appropriateness of which is verified, and delivery of the received information to a delivery destination are automatically performed via a network based on the information about electronic commerce (deal information) instructed from a request source, thereby reducing time loss in electronic commerce, which is caused when information is accepted or delivered. Furthermore, the request source can complete a commercial deal only by sending data such as an invoice, etc. to the collaboration system 4, which eliminates the need for operations such as generation of associated data, delivery of the data to a deal partner, etc. This also contributes to an increase in the efficiency of commercial deal operations.

What is claimed is:

1. A system accepting and delivering information received via a network, comprising:
a deal information storing unit storing information about a deal instructed by a sending source of the received information;
a received information appropriateness verifying unit verifying appropriateness of the received information based on the deal information;
a received information storing unit storing the received information appropriateness of which is verified by said received information appropriateness verifying unit; and
a delivering unit delivering the received information to a delivery destination if the deal information includes information about the delivery destination of the received information.

2. The system according to claim 1, further comprising
a deal information registering unit registering the deal information instructed from the sending source of the received information to said deal information storing unit.

3. The system according to claim 1, further comprising
a received information editing unit editing the received information based on the deal information, wherein
said delivering unit delivers received information edited by said received information editing unit.

4. The system according to claim 1, wherein
said delivering unit delivers the received information to each of a plurality of delivery destinations if the deal information includes information about the plurality of delivery destinations as information concerning the received information.

5. The system according to claim 1, wherein
the deal information is a document written by a markup language.

6. A system accepting and delivering information received via a network, comprising:
deal information storing means for storing information about a deal instructed by a sending source of the received information;
received information appropriateness verifying means for verifying appropriateness of the received information based on the deal information;
received information storing means for storing the received information appropriateness of which is verified by said received information appropriateness verifying means; and
delivering means for delivering the received information to a delivery destination if the deal information includes information about the delivery destination of the received information.

7. A computer-readable storage medium on which is recorded a control program for causing a computer to execute a control for accepting and delivering information received via a network, the control program comprising:
directing the computer to verify the appropriateness of the received information based on information about a deal instructed by a sending source of the received information;
directing the computer to store the received information the appropriateness of which is verified; and
directing the computer to deliver the received information to a delivery destination if the deal information includes information about the delivery destination of the received information.

8. A computer data signal embodied in a carrier wave and representing a control program for executing a computer to perform a control for accepting and delivering information received via a network, the control program comprising:
directing the computer to verify the appropriateness of the received information based on information about a deal instructed by a sending source of the received information;
directing the computer to store the received information the appropriateness of which is verified; and
directing the computer to deliver the received information to a delivery destination if the deal information includes information about the delivery destination of the received information.
